(19) United States
(12) Patent Application Publication
(10) Pub. No.: US 2012/0173002 A1
(43) Pub. Date: Jul. 5, 2012

(54) TWO-DEGREE-OF-FREEDOM CONTROL HAVING AN EXPLICIT SWITCHING FOR CONTROLLING CHEMICAL ENGINEERING PROCESSES

(75) Inventors: Matthias Zipplies, Neustadt (DE); Ortwin Keil, Obrigheim (DE); Veit Hagenmeyer, Ludwigshafen (DE); Marcus Nohr, Neustadt (DE)

(73) Assignee: BASF SE, Ludwigshafen (DE)

(21) Appl. No.: 13/395,550

(22) PCT Filed: Sep. 13, 2010
(86) PCT No.: PCT/EP2010/063395

§ 371 Date: Mar. 12, 2012

(30) Foreign Application Priority Data
Sep. 17, 2009 (EP) 09170546.7

(51) Int. Cl. G05B 13/02

(52) U.S. Cl. 700/8; 700/12

(57) ABSTRACT

The present invention relates to a method for performing closed-loop control of process-engineering processes, in which setpoint value trajectories are provided for closed-loop control variables, closed-loop control variables and further state variables of the process are detected, control errors are calculated and closed-loop controller manipulated variables are calculated therefrom by means of a control algorithm, and in addition pilot controller manipulated variables are determined, resulting manipulated variables are calculated from closed-loop controller manipulated variables and pilot controller manipulated variables and are set in the process, wherein the structure of the control algorithm and/or of the pilot control are/is changed as a function of closed-loop control variables, further state variables and/or setpoint value trajectories. Furthermore, the invention relates to a closed-loop control device and to a computer program for carrying out the method.

The present invention relates to a method for performing closed-loop control of process-engineering processes, in which setpoint value trajectories are made available for closed-loop control variables, closed-loop control variables and further state variables of the process are detected, control errors are calculated and closed-loop controller manipulated variables are calculated therefrom by means of a control algorithm, and in addition pilot controller manipulated variables are determined, resulting manipulated variables are calculated from closed-loop controller manipulated variables and pilot controller manipulated variables and are set in the process. Furthermore the invention relates to a closed-loop control device and to a computer program for carrying out the method.

In process-engineering processes on an industrial scale, in the last few years there has been an increasing trend toward automation, a main reason for which has been the desire for reproducibility and reliability of installations. In particular, in the chemical and pharmaceutical industries, in addition to continuous processes discontinuous processes are also frequently used for manufacturing, cleaning or conditioning products which often place increased demands on the process control.

Reactors which are operated in a batch operating mode or semi-batch operating mode and in which the product quality depends in a decisive way on the profile of the process conditions such as pressure and temperature over the batch duration for example, are widespread. In particular in the case of reactions which are associated with a large increase or drop in temperature or which are highly exothermic or endothermic, frequently demanding closed-loop control tasks come about which cannot be performed with classic closed-loop control methods, or can only be performed in an unsatisfactory way. In the last few years, these closed-loop control tasks have also been made more difficult by the trend toward ever larger reactors since in such reactors the ratio of the reaction volume to the heat-transmitting area becomes less favorable.

However, difficult-to-perform closed-loop control tasks occur not only during the operation of reactors but likewise during the operation of further process-engineering apparatuses and installations for converting material and separating material, for example in the case of crystallizers, chromatography columns, distillation columns, rectification columns or absorption columns.

In classic closed-loop control methods such as PI or PID control systems, only the profile of the deviation of a closed-loop control variable from its setpoint value is taken into account in order to determine therefrom a manipulated variable which is intended to counteract the control error.

In the case of processes of the type presented above, which react, for example, sensitively to changes in the process conditions, a simple PID closed-loop control system is often not sufficient to achieve the desired goal. In many cases, the possibility of improvement is presented by a cascaded closed-loop control in which a superordinate closed-loop controller generates setpoint values for a subordinate closed-loop controller.

In addition, several further closed-loop control concepts have been developed in order to solve certain classes of closed-loop control problems, for example adaptive closed-loop controllers, learning closed-loop controllers such as neural networks, or model-based and optimization-based closed-loop control methods such as the model-predictive closed-loop control system.

U.S. Pat. No. 6,144,897 discloses a model-predictive closed-loop controller for chemical reaction processes. Both the model on which the prediction is based and the closed-loop controller itself can be adapted to the respective installation state. Compared to other model-predictive closed-loop control methods, this method is distinguished by a mathematical model which is easy to solve and therefore permits rapid prediction of components in the reaction mixture.

Another approach is pursued in the laid-open patent application DE 102 26 670 A1 which discloses a closed-loop control method which takes into account particular features of non-linear, time-variable processes. The example used is a process-engineering batch process in which the reactor content is firstly brought to a certain temperature during a heating period and this temperature is then kept constant during the reaction phase. The closed-loop control method is suitable for processes in which the profile of closed-loop control variables and closed-loop controller manipulated variables is known in principle from the outset, for example in the base of batch processes which are repeatedly carried out with the same starting materials and the same formulation. Profiles which are determined in advance for these variables are stored as trajectories and recalled during the process sequence and added to the closed-loop controller and to the process. The actual closed-loop control of the process occurs along the predetermined trajectories, for example with PI or PID closed-loop controllers.

A promising concept comprises closed-loop control methods with pilot control, which, depending on the version, are also referred to as closed-loop control with two degrees of freedom. For example, EP 1 267 229 B1 discloses a closed-loop control method for powering up and powering down process-engineering processes, for example in power stations, which method uses model-based pilot controllers for predefining manipulated variables for the process on which closed-loop control is to be performed. For this purpose, offline simulation calculations are carried out in advance in order to obtain optimum setpoint value trajectories which are stored, read out during the process sequence and used for influencing the manipulated variables. The model can also be made to follow the current process state and optimization calculations based thereon are carried out repeatedly.

In the article “Feedforward control with online parameter estimation applied to the Chylla-Haase reactor benchmark” by K. Graichen, V. Hagenmeyer and M. Zeitz (Journal of Process Control, 16, 2006, pp 733-745), the performance capability of a closed-loop controller with pilot controller is demonstrated on the basis of an exemplary semi-batch process (Chylla-Haase polymerization reactor) which is known in the specialist literature. An extended Kalman filter is used to estimate non-measurable state variables which are used for adapting the pilot control.

A similar method is described in the article “Flatness-based two-degree-of-freedom control of industrial semi-batch reactors using a new observation model for an extended Kalman filter approach” by V. Hagenmeyer and M. Nohr (International Journal of Control, Vol. 81, No. 3, 2008, pp 428-438). In said document, a closed-loop control method with pilot control is applied to an industrial semi-batch reactor in order to perform closed-loop control on the temperature during a chemical conversion of the starting materials in the reactor. The reactor is provided with a cooling jacket through which a heat carrier medium flows. The input temperature of the heat carrier medium serves as a closed-loop controller manipulated variable. An extended Kalman filter is used for determining the variables reaction heat and heat transfer coefficient, which are necessary for the closed-loop control and which cannot be measured directly in the process.

However, even with this approach it is not possible to satisfactorily perform all the closed-loop control tasks. In particular, this applies to processes in which the actual closed-loop control task is subject to limitations. For example, the reactor temperature is a typical closed-loop control variable when closed-loop is performed on control batch reactors or semi-batch reactors. In this context, limitations such as minimum and maximum permissible values of the cooling capacity or of the pressure in the reactor must frequently be complied with.

The invention described in the text which follows is based on the object of making available a method for performing closed-loop control of process-engineering processes which ensures optimized process control with reliable compliance with limitations.

In order to achieve this object, a closed-loop control method according to claim 1 and a closed-loop control device according to claim 14 are proposed. Advantageous refinements of the invention are presented in subclaims 2 to 13. In addition, a computer program according to claim 15 is proposed.

Process-engineering processes on which the closed-loop control method according to the invention can be applied can generally be characterized by state variables. By using these state variables it is possible to arrive at conclusions about the state of the process at any desired time. Some of the state variables can usually be measured directly or in the process, these being, for example, volume flows or mass flows, pressure, temperature, density, viscosity or else concentrations of individual components of a mixture of materials or a class of substances. Other state variables can only be measured with a high degree of expenditure or not at all—these being, for example, the complete composition of a mixture of materials, particle size distributions, chain length distributions, melt flow index or cooling capacities.

A number of the non-measurable state variables can be determined from other, measurable or non-measurable, state variables using mathematical models. A simple example of this is a material system composed of two substances whose concentrations can be calculated in an unambiguous fashion from the measured values for the pressure and temperature by means of phase equilibrium relationships. The determination of non-measurable state variables can be based both on current measured values and on information about the previous profile of specific variables.

In the text which follows, closed-loop control variables refers to state variables of a process-engineering process whose values are to be selectively influenced by the method according to the invention. These are typically state variables which have a great influence on the objectives to be reached, for example a concentration of a component in a product discharge of a distillation column or the temperature in a reactor whose value is critical for the product quality. Closed-loop control variables selected are often state variables for which predefined limits must not be exceeded or undershot, such as a maximum pressure or filling level in a container. Closed-loop control variables can be measurable state variables or non-measurable state variables. Of course, given the presence of a plurality of closed-loop control variables it is also possible to measure one closed-loop control variable directly while another closed-loop control variable is determined indirectly from other state variables.

The closed-loop control method according to the invention can use not only closed-loop control variables but also further state variables, for example, for calculating closed-loop control variables which cannot be measured directly. These variables are referred to in the text which follows as “further state variables”. These can also be measured in or on the process or can be determined on the basis of other further state variables.

According to the invention, prescriptions in the form of setpoint values are made for closed-loop control variables. These can be, on the one hand, values which remain constant over the time period of the process profile, but, on the other hand, also values which are variable over the time period. Setpoint value prescriptions over a certain time period are referred to as setpoint value trajectories. These can be, for example, values which are constant over time periods, ramps, polygonal lines or other constant continuous or discontinuous profiles of the setpoint values. The special case of a setpoint value which is constant over the entire time period of the process sequence is therefore also covered by the term setpoint value trajectory.

The detection of closed-loop control variables or of further state variables can also be carried out in different ways. Depending on the variable to be detected and the specific process-engineering process, such variables can be determined, for example, using known physical measuring principles. Examples of this are classic through-flow measuring devices, pressure pickups or temperature sensors. Concentrations of various substances can be determined, for example, by means of gas chromatography or spectroscopic methods such as NMR (nuclear magnetic resonance) or NIR (near infrared spectroscopy).

The detection of closed-loop control variables which cannot be measured directly or further state variables can frequently be carried out by means of mathematical relationships which range between very simple ones and complex ones. For example, the mass flow rate of an individual component can very easily be calculated in a mixture which itself cannot be measured directly, from a measured overall mass flow rate and the measured concentration of the respective component.

In the case of relatively complex relationships between measurable and non-measurable state variables, state estimating methods can advantageously be used for detecting the variables of interest. Examples of such state estimating methods are Luenberger observers, Kalman filters or extended Kalman filters, such as are described, for example, in the articles cited above by Graichen/Hagenmeyer/Zeitz and Hagenmeyer/Nohr, respectively. The methods as such as well as possibilities for adapting to the process on which closed-loop control is to be respectively performed are known. In one preferred embodiment, an extended Kalman filter is used as a state estimating method which is based on state variables (y*) which can be measured directly in the process, in order to detect closed-loop control variables (y) and/or further state variables (ŷ).

Control errors are calculated through comparison of closed-loop control variables with their current respective setpoint values. In turn, closed-loop controller manipulated variables are determined on the basis of these control errors by means of a control algorithm. Variables whose change in the process has as large as possible an influence on the closed-loop control variables are generally selected as manipulated variables in order to counteract the control errors. If, for example, the filling level is to be subjected to closed-loop control in a container, the inflow quantity or outflow quantity are suitable as manipulated variables. Manipulated variables of the closed-loop control method according to the invention can themselves be setpoint values of subordinate closed-loop control systems here. In the example of the filling level closed-loop control, it would therefore be possible for the inflow quantity to be a setpoint value for a subordinate closed-loop control system, which in turn has, for example, the valve position of a valve in the inflow with respect to the container as a manipulated variable.

In the text which follows, the term “resulting manipulated variable” is used for values of the manipulated variables which are set in the process. A resulting manipulated variable can be identical to a closed-loop controller manipulated variable which is determined by the control algorithm. However, according to the invention at least one resulting manipulated variable is calculated from a closed-loop controller manipulated variable and from a further component, a pilot controller manipulated variable. In addition, it is also possible to influence values by means of external prescriptions, for example by means of manual inputting or by means of a signal which is made available by an information-processing system.

In the text which follows, pilot control is understood to mean that pilot controller manipulated variables are determined by means of an algorithm on the basis of setpoint values, closed-loop control variables or further state variables. In this context, process knowledge is used to relieve and to improve the closed-loop control of the process. A pilot controller according to the invention can comprise state-dependent calculation rules which define a relationship between setpoint values, closed-loop control variables, further state variables or else closed-loop controller manipulated variables, on the one hand, and pilot controller manipulated variables resulting therefrom, on the other, for example in the form of a mathematical model.

State-dependent calculation rules which take into account the behavior of the process-engineering process which is to be subjected to open-loop control are preferably used. In particular, pilot controllers which invert the steady-state or dynamic behavior are employed. This means that the pilot controller manipulated variables are calculated in such a way that the process-engineering process follows precisely one setpoint value trajectory when the pilot controller manipulated variables are applied and the process is not subject to any faults. Such a calculation, referred to as system inversion, is easily possible for what are referred to as differentially flat systems, and said calculation is known from the specialist literature.

In addition, the calculation rules can be predefined time-dependent and/or state-dependent trajectories, for example profiles, ramps or other predefined forms of the trajectories which are constant, for example, on a piece-by-piece basis over time and have state-dependent parameters. It is also possible to provide, as calculation rules, trajectories which have been optimized in advance offline.

The structure of a pilot controller is determined by various factors, for example the underlying type of calculation rule for pilot controller manipulated variables or the logic combination of variables which are used for the calculation. In addition, a calculation rule is defined by one or more parameters by means of which pilot controller manipulated variables are determined. Which parameters are used depends on the respective structure of the calculation rules. If, for example, the calculation rule is a function which is constant in certain sections, the times which define the sections and the values of the function in the respective sections are considered to be parameters of the pilot controller. For other types of calculation rules, other parameters, for example coefficients in the value domain or time domain, are correspondingly obtained.

Different approaches, such as are known from the specialist literature, are possible as control algorithms. For example, PI or PID algorithms or switching closed-loop controllers (sliding mode). It is also possible for there to be closed-loop controllers which have an input and an output, referred to as SISO closed-loop controllers, as well as closed-loop controllers with multiple input and outputs, referred to as MIMO closed-loop controllers. The structure of a control algorithm is determined by different features such as the basic design of the algorithm or the assignment of closed-loop control variables and manipulated variables. In the case of PI or PID closed-loop controllers, consideration is to be given, for example, as a further structural feature, to whether the amplification of the control algorithm, that is to say the P component, is configured in a fixed or variable fashion, for example in the form of gain scheduling. Similarly to the pilot control, the control algorithms have different parameters which affect the determination of the closed-loop controller manipulated variables. Examples of these are the amplification, the derivative time and the reset time in the case of the PID algorithm.

The closed-loop control method according to the invention can also be cascaded. In this context, the process-engineering process is divided in terms of information technology and closed-loop control technology into two or more subprocesses which are each assigned at least one closed-loop controller which is based on control algorithms as described above. Cascaded means that at least one of the subprocess controllers receives one or more setpoint values from a superordinate closed-loop controller. A pilot controller manipulated variable can be superimposed on the one or more setpoint values. Superordinate closed-loop controllers can also be referred to as master controllers, and subordinate controllers as slave controllers. FIG. 4 shows a basic illustration of a cascaded method according to the invention. A plurality of slave controllers can be assigned to one master controller. Likewise, a slave controller itself can be a master controller for slave controllers which are subordinate to it. Such a configuration is referred to as multiple cascading. According to the invention, at least one resulting manipulated variable in at least one subprocess is calculated from a closed-loop controller manipulated variable and a pilot controller manipulated variable.

In one preferred embodiment, the process-engineering process is divided into two or more subprocesses, and resulting manipulated variables of at least one master controller and at least one slave controller which is subordinate to it are calculated from the respective closed-loop controller manipulated variables and pilot controller manipulated variables which are assigned thereto. In addition, further superordinate or subordinate closed-loop controllers may be present with or without pilot control.

The method according to the invention for performing closed-loop control of process-engineering processes also comprises a switching logic which can process different information, for example information about setpoint values and their trajectories, state variables of the process which are measured or detected in some other way, as well as structures and parameters of the control algorithm or of the pilot control. External prescriptions, for example in the form of setpoint values, limits the chronological profiles thereof can also be processed externally by the switching logic. On the basis of this information and of predefined relationships between this information, the switching logic determines whether structures of the control algorithm or of the pilot controller are to be changed. In this context it is also possible to make changes to the associated parameters.

The terms “control algorithm” and “pilot controller” relate to the entire method according to the invention and are not to be understood strictly in the singular. In the case of a cascaded method, this is to be understood, for example, as including the control algorithms and pilot controllers of all the closed-loop controllers, irrespective of how or where they are implemented in terms of information technology.

In one preferred embodiment, the closed-loop control method according to the invention is cascaded, resulting manipulated variables of at least one master controller and at least one slave controller which is subordinate thereto are calculated on the basis of the respective closed-loop controller manipulated variables and pilot controller manipulated variables assigned thereto, and the structure of the control algorithm and/or the pilot controller of the at least one slave controller are changed by the switching logic.

A set of structures and parameters of the control algorithm and of the pilot controller are referred to below as “switching mode”. If it becomes apparent from the evaluation of the information in the switching logic that a change is being performed, switching over from one switching mode into another switching mode is present. In this context, these can be structural changes either only in the control algorithm or only of the pilot controller or else in both. In this context, associated parameters can also be changed.

Preferred structural changes in the control algorithm relate to a change in the assignment of closed-loop control variables and closed-loop controller manipulated variables. Another advantageous structural change constitutes the selection of another control algorithm.

Structural changes of the pilot controller are preferably changes between various state-dependent calculation rules. A structural change can advantageously also consist in other variables being used for the calculation. A further preferred structural change of the pilot controller is the selection of one or more further or different pilot controller manipulated variables.

Furthermore, one or more setpoint value trajectories are assigned to a switching mode. In one preferred embodiment of the closed-loop control method according to the invention, at the changeover from one switching mode into a new switching mode one or more setpoint value trajectories are recalculated. During a switching mode, the switching logic can also bring about the recalculation of setpoint value trajectories, for example if closed-loop control variables or further state variables approach limiting values, and when a threshold value of the control error is exceeded or undershot, or owing to external prescriptions. After recalculation of one or more setpoint value trajectories, the parameters of the control algorithm or of the pilot control can be changed.

In one advantageous refinement of the invention, different, chronologically successive switching modes occur as a function of the switching logic and the respective process conditions. The changes from one switching mode to the next can affect the pilot controller, the control algorithm, the recalculation of a setpoint value trajectory or combinations thereof.

In one preferred embodiment, the closed-loop control method according to the invention is used for monitoring and complying with limits for one or more state variables. The corresponding limiting values are used in the switching logic in order to determine the conditions for a changeover into a new switching mode or else to bring about the recalculation of setpoint value trajectories. In a further preferred embodiment, the closed-loop control method according to the invention is used to approach limits of one or more state variables in a targeted fashion. Such process control has the advantage that the process can be operated more economically, for example with respect to quality requirements or the space/time yield.

In order to implement the closed-loop control method, a closed-loop control device is preferably provided which comprises in each case at least one signal generator for making available setpoint value trajectories for closed-loop control variables, a device for detecting closed-loop control variables and further state variables of the process, a closed-loop controller which determines closed-loop controller manipulated variables on the basis of control errors by means of a control algorithm a pilot controller for determining pilot controller manipulated variables, a means for calculating resulting manipulated variables from closed-loop controller manipulated variables and pilot controller manipulated variables, and a means for adjusting the resulting manipulated variables in the process, wherein the closed-loop control device also has at least one switching logic which is suitable for changing the structure of the control algorithm and/or of the pilot controller as a function of closed-loop control variables, further state variables and/or setpoint value trajectories. Devices for detecting closed-loop control variables and further state variables as well as means for calculating and for setting the manipulated variables in the process are known to a person skilled in the art, as are signal generators, closed-loop controllers, control algorithms, pilot controllers and possibilities for implementation thereof using hardware and software.

In one preferred embodiment of the invention, the pilot controller, control algorithms and the calculation rules of the switching logic are implemented in a computer program having program code means, for example in a program which is created in a programming language or using commercially available software which is suitable for use in a closed-loop control of process-engineering processes.

In one particularly preferred embodiment, the computer program is configured so as to be capable of running on a computer and is provided with interfaces for communication with the process-engineering process. The communication can be carried out, for example, with a process control system by means of which nowadays many process-engineering processes are controlled. In the case of processes which do not have a process control system, the communication can take place via interfaces which permit data exchange with measuring devices and closed-loop controllers in the process. Such interfaces and their hardware and software implementations are known to a person skilled in the art. The computer in this context can be located in the vicinity of the process-engineering process, for example in a measurement station, but it can also be spatially remote and communicate with the process via customary network connections.

In a further preferred embodiment, the pilot controller, control algorithms and the calculation rules of the switching logic can be implemented at least partially as software modules in a process control system. In a further advantageous refinement of the invention, the pilot controller, control algorithms and the calculation rules of the switching logic are implemented or integrated completely in a process control system,

The method according to the invention for performing closed-loop control of process-engineering processes brings about improved process control. The processes can generally be operated closer to limits, as a result of which the space/time yield can usually be increased. The method according to the invention can be advantageously applied to a larger number of process-engineering processes. Particularly advantageous effects are evident in intermittent processes such as batch processes or semi-batch processes. In this context, it is frequently possible to shorten the batch time and to improve the reproducibility of a batch.

The invention will be explained further below with reference to the drawings, wherein the drawings are to be understood as basic illustrations. They do not constitute a restriction of the invention, for example with regard to structural features or applications. In the drawings:

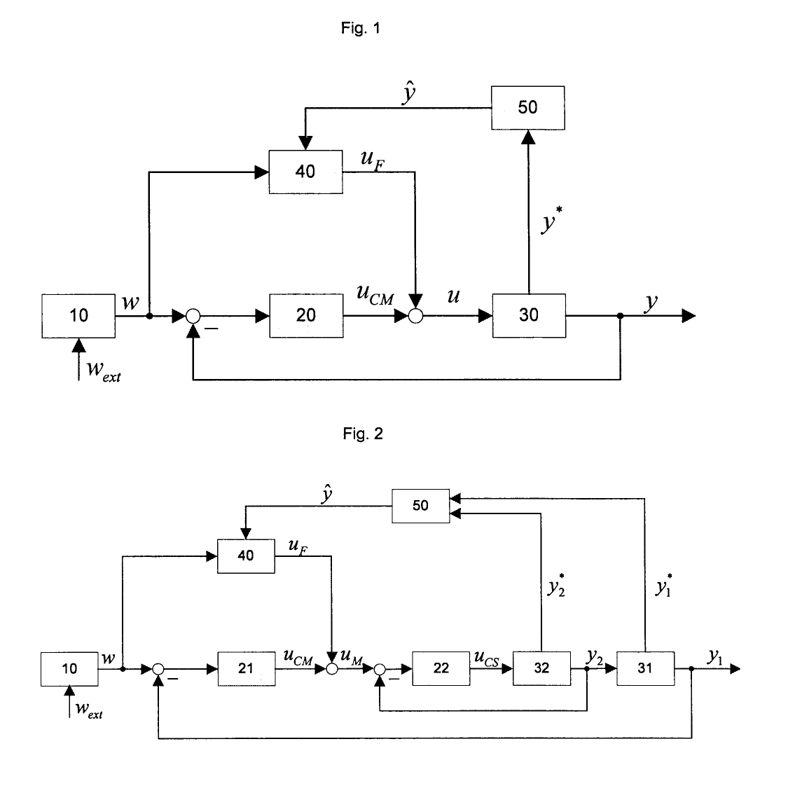

FIG. 1 shows a control loop with pilot controller and state estimator according to the prior art

FIG. 2 shows a control loop in a master-slave configuration with pilot controller and state estimator according to the prior art

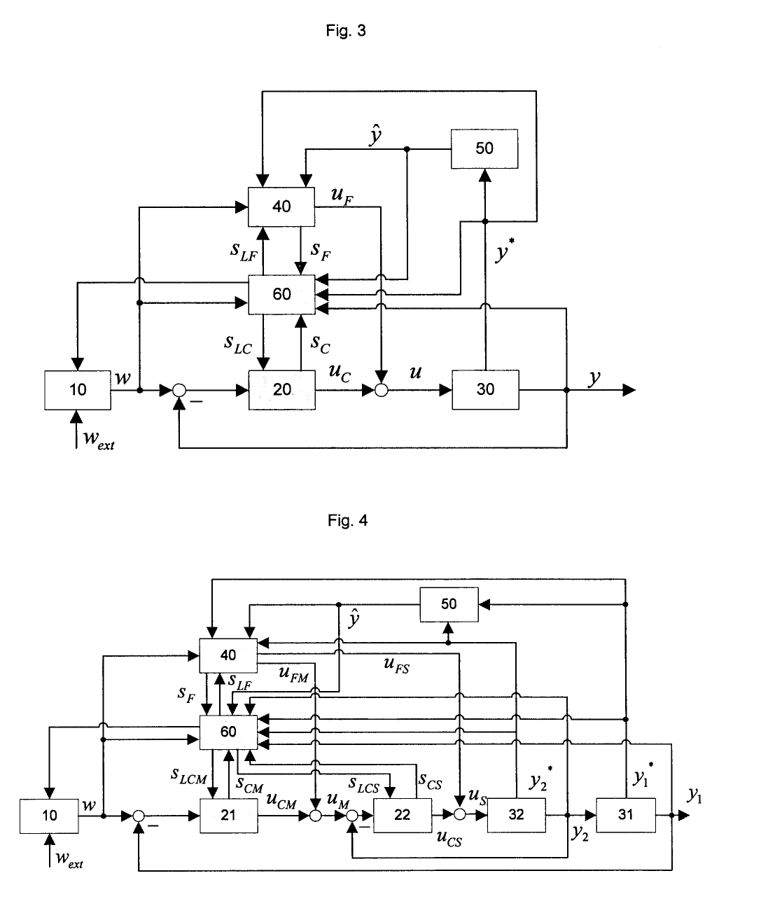

FIG. 3 shows an embodiment of the closed-loop control method according to the invention with pilot controller, state estimator and switching logic

FIG. 4 shows an embodiment of the closed-loop control method according to the invention with pilot controller, state estimator and switching logic in a master-slave configuration

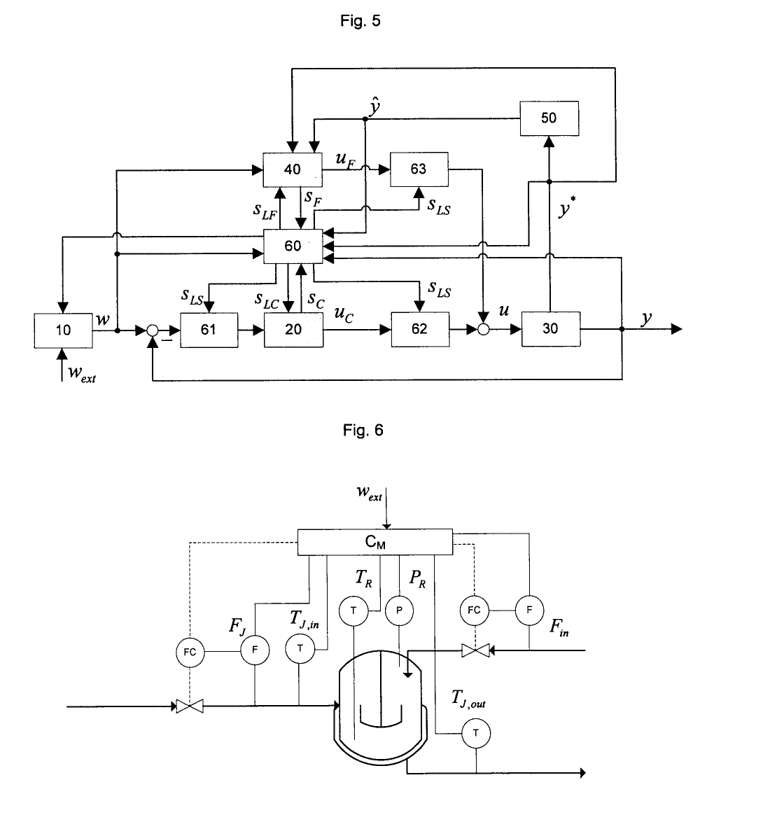

FIG. 5 shows an embodiment of the closed-loop control method according to the invention with pilot controller, state estimator, switching logic and selection blocks

FIG. 6 shows a basic outline of a semi-batch reactor with a cooling jacket and closed-loop control device according to the invention

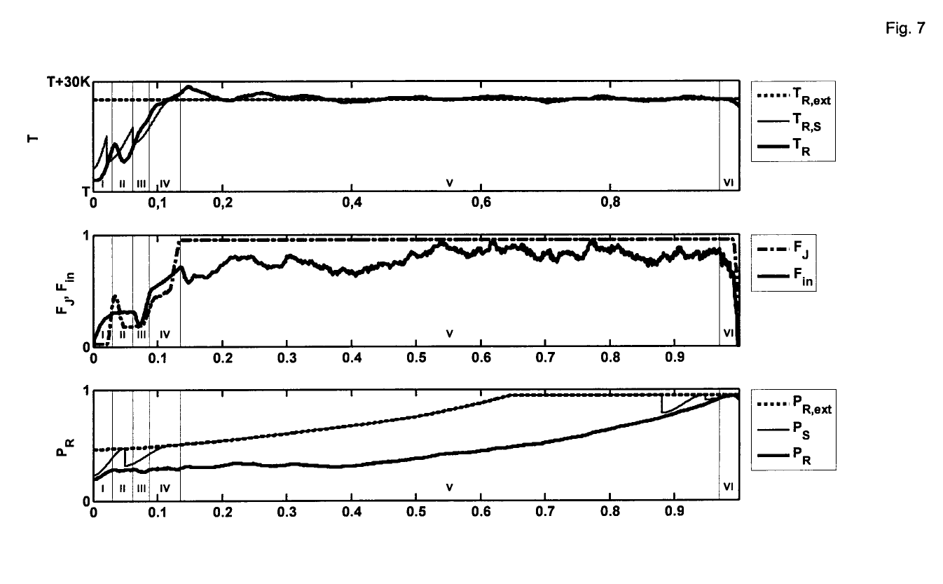

FIG. 7 shows time profiles of characteristic variables of the semi-batch process described in the example, and

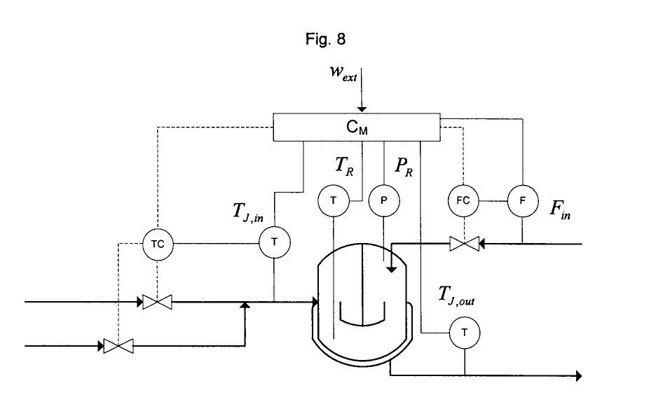

FIG. 8 shows a basic outline of a further semi-batch reactor with a cooling jacket and closed-loop control device according to the invention

### LIST OF THE REFERENCE SYMBOLS USED

10 . . . Signal generator for setpoint value trajectories
20 . . . Closed-loop controller
21 . . . Master controller
22 . . . Slave controller
30 . . . Process
31 . . . First subprocess
32 . . . Second subprocess
40 . . . Pilot controller
50 . . . State estimator
60 . . . Switching logic
61 . . . Selection block at the closed-loop controller input
62 . . . Selection block at the closed-loop controller output
63 . . . Selection block at the pilot controller output

### List of Symbols Used

C_{M} . . . Closed-loop control device
Fᵢₙ . . . Starting material inflow
Fⱼ . . . Coolant inflow
P . . . Pressure
P_{S} . . . Predefined pressure
s_{C} . . . Signals from closed-loop controller to switching logic
s_{CM} . . . Signals from closed-loop controller to switching logic (master controller)
s_{CS} . . . Signals from closed-loop controller to switching logic (slave controller)
s_{F} . . . Signals from pilot controller to switching logic
s_{LC} . . . Signals from switching logic to closed-loop controller
s_{LCM} . . . Signals from switching logic to closed-loop controller (master controller)
s_{LCS} . . . Signals from switching logic to closed-loop controller (slave controller)
s_{LF} . . . Signals from switching logic to pilot controller
s_{LS} . . . Signals from switching logic to selection block
T_{J, in} . . . Temperature of coolant inflow
T_{J, out} . . . Temperature of coolant outflow
T_{R} . . . Temperature in the reaction mixture
T_{RS} . . . Predefined reaction temperature
u . . . Resulting manipulated variable
u_{C} . . . Closed-loop controller manipulated variable
u_{CM} . . . Closed-loop controller manipulated variable (master controller)
u_{CS} . . . Closed-loop controller manipulated variable (slave controller)
u_{F} . . . Pilot controller manipulated variable
u_{FM} . . . Pilot controller manipulated variable (master controller)
u_{FS} . . . Pilot controller manipulated variable (slave controller)
u_{M} . . . Resulting manipulated variable (master controller)
u_{S} . . . Resulting manipulated variable (slave controller)
w . . . Setpoint value
wₑₓₜ . . . External setpoint value
wₜ . . . Setpoint value trajectory
y . . . Closed-loop control variable
y₁ . . . Closed-loop control variable (master controller)
y₂ . . . Closed-loop control variable (slave controller)
ŷ . . . Further state variable
y* . . . Measured state variable
y₁* . . . Measured state variable of first subprocess
y₂* . . . Measured state variable of second subprocess

FIG. 1 illustrates a control loop with pilot controller 40 and state estimator 50 such as is known from the prior art. A signal generator 10 makes available setpoint values w which are compared with their respective closed-loop control variables y. In this context, external setpoint values wₑₓₜ can be predefined for the signal generator 10, for example by means of a superposed system for process automation or as a manual input by an installation operator. The differences between the setpoint values w and their respective closed-loop control variables y, referred to as the control errors, are fed to a closed-loop controller 20 which calculates closed-loop controller manipulated variables u_{CM} therefrom. Parallel with this, a pilot controller 40 determines pilot controller manipulated variables u_{F} from the setpoint values w and further state variables ŷ. The resulting manipulated variables u, which are set in the process 30, are calculated from said pilot controller manipulated variables and from the closed-loop controller manipulated variables u_{CM}. Closed-loop control variables y are obtained and are in turn used to calculate the control errors. If all the further state variables ŷ cannot be measured directly in the process 30, a state estimator 50, which determines the required variables from measured state variables y*, is provided.

The control loop which is illustrated in FIG. 2 forms an extension of the control loop from FIG. 1 which is described above in that two closed-loop controllers are used in a cascaded form in what is referred to as a master-slave configuration. The process to be subjected to closed-loop control is subdivided into a first subprocess 31 and a second subprocess 32. Closed-loop control variables y₁ of the first subprocess 31 are fed back in order to calculate the control errors for the master controller 21 by means of the predefined setpoint values w. The closed-loop controller manipulated variables u_{CM} which are determined by the master controller 21 are combined mathematically with pilot controller manipulated variables u_{F} and yield the resulting manipulated variables of the master controller u_{M}. These manipulated variables function as setpoint values for the slave controller 22. Control errors for the slave controller 22 are formed from said setpoint values by comparison with closed-loop control variables y₂ of the second subprocess 32, and said slave controller determines closed-loop controller manipulated variables u_{CS} said control errors. These closed-loop controller manipulated variables u_{CS} are set in the second subprocess 32. A state estimator 50 can also be provided in this control loop, said state estimator 50 determining, from measured state variables of the second subprocess y₁* and of the second subprocess y₂*, further state variables ŷ which can be used in the pilot controller 40 in order to calculate pilot controller manipulated variables u_{F}.

FIG. 3 illustrates a control loop according to the invention using the example of a simple control loop which is analogous to FIG. 1. The setpoint value generator 10, closed-loop controller 20, process 30, pilot controller 40 and the optional state estimator 50 carry out the same functions as described in FIG. 1. According to the invention, the control loop also has a switching logic 60 which can process different information as input signals, for example setpoint values w, closed-loop control variables y, measured state variables y*, further state variables ŷ, or signals from the closed-loop controller s_{C} or from the pilot controller s_{F}. On the basis of this information, signals s_{LC} and s_{LF} can be generated in the switching logic 60 by means of state-dependent calculation rules and transmitted to the closed-loop controller 20 and to the pilot controller 40. Structures or parameters of the control algorithm or of the pilot controller 40 can be changed as a function of these signals. Furthermore, the switching logic 60 can also influence the signal generator for setpoint value trajectories 10.

FIG. 4 shows an example of a cascaded control loop according to the invention, which control loop corresponds in its basic design to that represented in FIG. 2. The setpoint value generator 10, master controller 21, slave controller 22, subprocesses 31 and 32, pilot controller 40 and the optional state estimator 50 carry out the same functions as those described in FIG. 2. According to the invention, a switching logic 60 is provided which can access different information from the process in its entirety or from the individual subprocesses, for example setpoint values w, closed-loop control variables y₁ and y₂, measured state variables y₁* and y₂*, further state variables ŷ as well as signals s_{CM} and s_{CS} from the closed-loop controllers or signals s_{F} of the pilot controller. On the basis of this information, signals s_{LCM}, s_{LCS} and s_{LF} can be generated in the switching logic 60 by means of state-dependent calculation rules and transmitted to the master controller 21, the slave controller 22 and the pilot controller 40. Furthermore, the switching logic 60 can also influence the signal generator for setpoint value trajectories 10.

The signals of the switching logic 60 transmitted to the closed-loop controllers 21, 22 and to the pilot controller 40 can cause structures or parameters of the control algorithm or of the pilot controller 40 to be changed. In this context, structures and parameters can be changed only in a closed-loop controller, only in the pilot controller, but also in a plurality of closed-loop controllers and/or the pilot controller in combination. Changes are preferably carried out in a closed-loop controller and the assigned pilot controller simultaneously.

FIG. 4 illustrates for the sake of clarity a cascaded control loop with a master controller 21 and a slave controller 22. The closed-loop control behavior according to the invention is, however, not restricted to this configuration but can be used advantageously in any desired combinations of master controllers and slave controllers. It is therefore possible, for example, in the case of multiple cascading of the control loop, for the slave controller 22 itself in turn to be the master controller for further closed-loop controllers. The switching logic can be used both in control loops with just one closed-loop control variable and one manipulated variable, referred to as SISO systems, as well as also in MIMO systems with a plurality of closed-loop control variables and manipulated variables. Both SISO and MIMO systems can be cascaded, and combinations are also covered by the invention, for example in the case of a superordinate MIMO closed-loop controller with a subordinate SISO closed-loop controller.

### EXAMPLE

A preferred embodiment of the method according to the invention has been applied to an industrial semi-batch process. This is a heavily exothermal polyaddition reaction. A first starting material was placed in a stirred tank reactor, as is illustrated schematically in FIG. 6. The inputting of a second starting material was carried out continuously via a line into the reactor. The flow rate Fᵢₙ of the second starting material was detected by means of a through-flow rate measuring device and set by means of a control valve. The lower part of the reactor was surrounded by a jacket through which cooling water flowed as a heat carrier medium. It was possible to influence the flow rate of the inflowing cooling water F_{J} by means of a further control valve. The cooling water inflow F_{J} and the cooling water temperature in the inflow T_{J, in} and in the outflow T_{J, out} was detected by means of measuring devices. Furthermore, the pressure in the reactor P and the temperature in the reaction mixture T_{R} were detected by means of measuring technology. All the measuring devices were connected to a closed-loop control device C_{M} according to the invention, with the result that the measured values were available for the closed-loop control method according to the invention as measured state variables y*.

The reaction process should be controlled in such a way that the highest possible space/time yield is achieved. On the one hand, the closed-loop control method obtained, as external prescriptions wₑₓₜ, the reaction temperature T_{RS} which was to be reached as quickly as possible in order to ensure a high reaction conversion rate. On the other hand, a pressure P_{S}, which should not be exceeded in the reactor, was predefined as a function of the current state of the process. This limiting value was calculated in the connected process control system on the basis of known process-engineering limits, essentially as a function of the filling level of the reactor and the reaction temperature T_{RS}.

The closed-loop control method according to the invention was implemented in a commercially available workstation computer using the program package MATLAB (The MathWorks Inc., Natick, Mass., USA) and connected to the process control system via the standard interface OPC (OLE for Process Control). The break-down of the closed-loop control method is represented schematically in FIG. 5 and corresponds to the closed-loop control block “C_{M}” in FIG. 6.

In order to achieve a high space/time yield it was necessary to operate the process 30 as near as possible to one or more given limits. In addition to the limit for the pressure, further restrictions were the maximum possible flow rate of the second starting material Fᵢₙ and the flow rate of the cooling water inflow F_{J}. These two flow rates were selected as manipulated variables u. The pressure P in the reactor and the temperature in the reaction mixture T_{R} were selected as closed-loop control variables y. The basis of the control algorithm formed three SISO-closed-loop controllers 20 with a corresponding pilot controller 40 with subsequent assignment of manipulated variables and closed-loop control variables:
Starting material inflow Fᵢₙ−Pressure P
Starting material inflow Fᵢₙ−Reaction temperature T_{R}
Cooling water inflow F_{J}−Reaction temperature T_{R}

A maximum two of these three individual closed-loop controllers were activated at the same time by the respective closed-loop control variables y and manipulated variables u_{C} being selected on the basis of signals s_{LS} of the switching logic 60 transmitted to the selection blocks 61 and 62. In an analogous fashion, the corresponding pilot controller manipulated variables u_{F} were selected on the basis of signals s_{LS} of the switching logic 60 which were transmitted to the selection block 63. In each case the associated flatness-based pilot controller (40, 63) was assigned to an active closed-loop controller (61, 20, 62). A pilot controller manipulated variable u_{F}, which represented the optimum manipulated variable in respect of the desired change in the setpoint value and the currently acting model system interference variables taken into account, was determined in the pilot controller 40 by means of system inversion of a mathematical model on the basis of closed-loop control variables y, measured state variables y* and state variables ŷ which were determined by the observer 50.

In the text which follows, the closed-loop control method according to the invention is explained in more detail on the basis of an exemplary batch run. FIG. 7 shows the time profiles of a number of selected variables of the process in standardized values. In the upper graphic, the profile of the reactor temperature is represented. The dotted straight line corresponds to the externally predefined reaction temperature T_{RS} which is to be reached as quickly as possible. The thin continuous curve shows the setpoint value trajectory which was made available by the setpoint value generator 10, for the reactor temperature, while the bold continuous curve represents the reactor temperature T_{R} which is actually measured. The central graphic represents the actual profiles of the manipulated variables of the starting material inflow Fᵢₙ as a continuous curve and cooling water inflow F_{J} as a dot-dash curve. In the lower graphic, the dotted curve denotes the externally predefined pressure P_{S} at every point in time. In a way which is analogous to the upper graphic, the thin continuous curve shows the calculated setpoint value trajectory for the pressure, while the bold continuous curve represents the pressure P which is actually measured.

When the closed-loop control method according to the invention is put into operation, a setpoint value trajectory for the closed-loop control variable, reactor temperature T_{R}, was initially generated on the basis of the current process information. In this first switching mode (I), the cooling water inflow F_{J} was selected as the manipulated variable in order to influence the reactor temperature T_{R}. The inflow of starting material Fᵢₙ was not used for closed-loop control in this mode but rather set along a previously calculated trajectory in the process. The pressure P was monitored to ensure that it could not exceed the predefined, state-dependent pressure P_{S}. The setpoint value trajectory for the reactor temperature T_{R} was recalculated at the time t=0.022 since the deviation between the current value and the setpoint value had become too large. This recalculation can be seen in FIG. 7 by virtue of the perpendicular drop in the thin continuous curve in the upper graphic.

In the reaction system in question there is in principle the risk of starting materials accumulating without reacting. In the case of a suddenly starting reaction, the pressure and temperature could increase very quickly, with the result that the process could get out of control. For this reason, a calculation rule for the current conversion rate is implemented in the observer 50, and an associated limiting value is predefined in the switching logic 60. At the time t=0.031, this limiting value was reached. On the basis of the rules stored in the switching logic 60, the system is then switched over from a fixed trajectory for the starting material inflow Fᵢₙ to a state-dependent trajectory, which constituted a switching over of the structure in the pilot controller 40. The assignment of the manipulated variable of the cooling water inflow F_{J} to the closed-loop control variable, reactor temperature T_{R}, remained unchanged in the new switching mode (II).

As is apparent from the lower graphic in FIG. 7, the setpoint value trajectory for the pressure P was recalculated during the switching mode (II). This process was triggered by means of a rule in the switching logic 60 after the difference between the predefined pressure P_{S} and the actual pressure P had undershot a minimum value. However, this recalculation changed neither the structure of the control algorithm nor that of the pilot controller, with the result that there was no changeover into a new switching mode.

At the time t=0.062, the accumulation of the starting materials was reduced to such an extent that a corresponding calculation rule in the switching logic 60 triggered the changeover into the new switching mode (III). In this switching mode, the reactor temperature was no longer adjusted by means of the cooling water inflow F_{J} but rather by means of the starting material inflow Fᵢₙ as the manipulated variable. The calculation of the pilot controller manipulated variables was also changed in an analogous fashion. Consequently, a change in the structure of the control algorithm and of the pilot controller took place. The setpoint value trajectory for the reactor temperature T_{R} was also recalculated at this time, since the deviation from the setpoint value for the switching to the starting material inflow Fᵢₙ as the manipulated variable was too large. A trajectory was calculated for the cooling water inflow F_{J} and set in the process. The pressure P continued to be monitored.

At the time t=0.089, the accumulation limit was reached again, with the result that switching over into the new switching mode (IV) took place. This switching mode corresponds in its structure to the switching mode (II) already described above, and a change in structure of the control algorithm and pilot controller therefore took place again. The setpoint value trajectory for the reactor temperature T_{R} was not recalculated since the deviation between the setpoint value and the real value was low at this time.

The cooling water inflow F_{J} reached its maximum value at the time t=0.136. The closed-loop control of the reactor temperature T_{R} by means of the cooling water was therefore limited and the switching logic 60 initiated the changeover into the switching mode (V) which corresponded in its structure to the switching mode (III). The trajectory for the cooling water inflow F_{J} in the switching mode (V) consisted, however, of a constant value, its maximum value. This mode was maintained over the greater part of the batch running time. Toward the end of the running time, the setpoint value trajectory for the pressure P was recalculated twice, since the current pressure P undershot the difference value with respect to the externally predefined pressure P_{S}.

When the current pressure P exceeded its setpoint value at the time t=0.970, the switching mode (VI) was triggered by the switching logic 60. There was a change in structure of the control algorithm and pilot controller to the effect that the pressure P was now adjusted by means of the starting material inflow Fᵢₙ, and the reactor temperature T_{R} was adjusted again by means of the cooling water inflow F_{J}. This mode was maintained up to the end of the batch running time. The end of the batch run was determined by the formulation controller in the process control system on the basis of the metered quantity of starting material and was communicated to the closed-loop control method according to the invention.

The parameters of the closed-loop controllers which were active after the switching over were reinitialized for all changes in the closed-loop controller structure.

FIG. 8 illustrates a further reactor configuration in which the closed-loop control method according to the invention was successfully used. The difference from the example described above was that the cooling capacity in the jacket around the reactor was not influenced by the inflow of cooling water but rather by the setting of the cooling water inflow temperature T_{J, in} by means of a split-range closed-loop control system.

In comparison with the previous process control concept, which did not provide for any switching over of the control algorithm or pilot controller, in the two reactor configurations the method according to the invention was able to achieve a reduction in the metering time by 10% to 30% depending on the formulation of the batch. Furthermore, it was possible to increase the reproducibility of batches of the same type.

In the above example, the process-engineering process occurred essentially in a semi-batch reactor which was surrounded by a jacket through which cooling water flowed as the heat carrier medium. However, the invention is in no way restricted to this example. For example, further devices for exchanging heat in reactors are known to a person skilled in the art, such as half-coils, outside or inside the reactor, through which a heat carrier medium flows, but also devices in the reactor such as pipe coils through which there is a flow, or electrical heaters. A further customary method of discharging heat is evaporation cooling, in particular in the case of polymerization processes in which a gas phase is present or is produced by the reaction. A distinction is made here between the internal evaporation cooling in the reactor and external evaporation cooling, in which part of the gaseous reactor content is conducted into a heat exchanger which is connected to the reactor and condensed there. A liquid phase can also be cooled or heated in an external heat exchanger and all the known designs are possible here as heat exchangers, in particular also those which make use of the principle of evaporation cooling on the heat carrier side.

The closed-loop control method according to the invention can also be advantageously applied in such refinements of the example illustrated above. Depending on the respective conditions in terms of equipment, in particular one or more flow rates of fed-in starting materials, flow rates of fed-in heat carrier medium, temperature of the fed-in heat carrier medium, the power of a heater which is mounted in or on the reactor, the pressure in the reactor or in a heat exchanger which is connected to the reactor as well as flow rates or temperature of a heat carrier medium with respect to an external heat exchanger are suitable here as manipulated variables.

The invention is likewise not restricted to processes in which heat given off by a reaction has to be carried away. Even in processes which require heat it is possible to use the method according to the invention advantageously. The heat carrier medium here can, as described above, be water, but oil, some other fluid or even vapor, for example water vapor, are also possible.

The method according to the invention makes it possible to improve process control not only in the case of semi-batch reactors and batch reactors but also in processes in other process-technical equipment and installations for converting or separating materials, for example in the case of crystallizers, chromatography columns, distillation columns, rectification columns or absorption columns.

1. A method for performing closed-loop control of a process-engineering process, comprising:
providing a setpoint value trajectory (wₜ) for a closed-loop control variable (y),
detecting the closed-loop control variable (y) and a further state variable (ŷ) of the process,
calculating a control error from a comparison of the closed-loop control variable (y) and a setpoint value (w) of the closed-loop control variable,
determining a closed-loop controller manipulated variable (u_{C}) with a control algorithm, based on the control error,
determining a pilot controller manipulated variable (u_{F}),
calculating a resulting manipulated variable (u) from the closed-loop controller manipulated variable (u_{C}) and the pilot controller manipulated variable (u_{F}),
setting the resulting manipulated variable (u) in the process, and
changing a structure of a pilot controller and a logic combination of the closed-loop control variable (y) and the closed-loop controller manipulated variable (u_{C}) with a switching logic as a function of the closed-loop control variable (y), the further state variable (ŷ), the setpoint value trajectory (wₜ), or a combination thereof.

2. The method of claim 1,
wherein the method is cascaded, and
calculating a resulting manipulated variable comprises calculating a resulting manipulated variable of a master controller and a resulting manipulated variable of a slave controller which is subordinate thereto, based on respective closed-loop controller manipulated variables and pilot control manipulated variables assigned thereto.

3. The method of claim 2, comprising:
changing the structure of the pilot controller and the logic combination of the closed-loop control variable (y) and the closed-loop controller manipulated variable (u_{c}) of the slave controller are changed.

4. The method of claim 1, further comprising:
recalculating a setpoint value trajectory (wₜ).

5. The method of claim 1,
wherein changing the structure of the pilot controller comprises changing a state-dependent calculation rule or a predefined pilot control manipulated variable (u_{F}).

6. The method of claim 1, further comprising:
forming a pilot control manipulated variable (u_{F}) by system inversion during a switching mode.

7. The method of claim 1,
wherein detecting the closed-loop control variable (y), the further state variable (ŷ), or both, comprises a state estimating method based on a state variable (y*), which is measured directly.

8. The method of claim 7, wherein the state estimating method comprises an extended Kalman filter.

9. The method of claim 1, further comprising:
operating the process-engineering process in batch operating mode or semi-batch operating mode.

10. The method of claim 9,
wherein the process-engineering process employs a batch reactor or semi-batch reactor with heat exchanging equipment.

11. The method of claim 10, further comprising:
manipulating at least one manipulated variable selected from the group consisting of:
a flow rate of fed-in starting material,
a flow rate of fed-in heat carrier medium,
a temperature of fed-in heat carrier medium,
a power of a heater mounted in or on the reactor,
a pressure in the reactor or in a heat exchanger connected to the reactor, and
a flow rate or temperature of a heat carrier medium with respect to an external heat exchanger.

12. A closed-loop control device for performing a closed-loop control of a process-engineering process, the device comprising:
a signal generator configured to make available a setpoint value trajectory (wₜ) for a closed-loop control variable (y),
a device configured to detect a closed-loop control variable (y) and a further state variable (ŷ) of the process,
a closed-loop controller configured to determine a closed-loop controller manipulated variable (u_{C}) with a control algorithm, based on a control error,
a pilot controller configured to determine a pilot control manipulated variable (u_{F}), and
a switching logic configured to change a structure of the pilot controller and a logic combination of the closed-loop control variable (y) and the closed-loop controller manipulated variable (u_{C}) as a function of the closed-loop control variable (y), the further state variable (ŷ), the setpoint value trajectory (wₜ), or a combination thereof,
wherein the device is configured to calculate a resulting manipulated variable (u) from the closed-loop controller manipulated variable (u_{C}) and the pilot control manipulated variable (u_{F}), and
the device is configured to adjust the resulting manipulated variable (u).

13. A computer program having program code configured to carry out the method of claim 1,
wherein the computer program is configured to run on a computer, a process control system, or a corresponding computing unit.

14. The method of claim 1, further comprising selecting another control algorithm.

15. The method of claim 4, wherein the recalculating is at a changeover from one switching mode into a new switching mode.
